(19) United States
(12) Patent Application Publication
(10) Pub. No.: US 2004/0120357 A1
(43) Pub. Date: Jun. 24, 2004

(54) On-demand header compression

(76) Inventor: Sami Kekki, Helsinki (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/325,735

(22) Filed: Dec. 23, 2002

(51) Int. Cl. H04J 3/00

(52) U.S. Cl. 370/521

(57) ABSTRACT

The present invention relates to a method and system for controlling header compression in a packet data network, e.g. an IP based cellular network. Load information of the packet data network is obtained, and header compression is triggered in response to the result of an evaluation of the load information. In particular, the header compression can be applied only for one direction, provided that the load information indicates asymmetry. Thereby, the headers can be compressed only on demand and only in the direction where the traffic volume is higher and where, in effect, the transmission capacity is the bottleneck. As a result, header compression takes less processing power and thus allows more flows to be compressed.

### BACKGROUND OF THE INVENTION

1. Field of the Invention

The present invention relates to a method and system for controlling header compression in a packet data network, as for example an IP (Internet Protocol) based cellular network.

2. Description of the Prior Art

In communication networks using packet data transport, individual data packets carry in a header section an information needed to transport the data packet from a source application to a destination application. The actual data to be transmitted is contained in a payload section.

The transport path of a data packet from a source application to a destination application usually involves multiple intermediate steps represented by network nodes interconnected through communication links. These network nodes, called packet switches or routers, receive the data packet and forward it to a next intermediate router until a destination network node is reached which will deliver the payload of the data packet to the destination application. Due to contributions of different protocol layers to the transport of the data packet, the length of a header section of a data packet may even exceed the length of the payload section.

Data compression of the header section may therefore be employed to obtain better utilization of the link layer for delivering the payload to a destination application. Header compression reduces the size of a header by removing header fields or by reducing the size of header fields. This is done in a way such that a decompressor can reconstruct the header if its context state is identical to the context state used when compressing the header. Header compression may be performed at the network layer level, e.g. for IP headers, at transport layer level, e.g. for User Datagram Protocol (UDP) headers or Transport Control Protocol (TCP) headers, and even at application layer level, e.g. for Hyper Text Transport Protocol (http) headers.

Header compression in IP networks is a relatively processing intensive task for the interfaces. As a result, the maximum number of processed streams becomes limited. Moreover, the need for more processing power rises costs involved, especially when header compression is performed by a network processor type of apparatus. In cellular access networks, the most likely way of implementing transport features in the network nodes is to use a network processor. A problem with IP over cellular links when used for interactive voice conversations is the large header overhead. Speech data for IP telephony will most likely be carried by the real time protocol (RTP). A packet then has, in addition to link layer framing, have an IP header comprising 20 octets, a UDP header comprising 8 octets, and a RTP header comprising 12 octets, which leads to a total of 40 octets. In IPv6, the IP header even amounts to 40 octets, leading to a total number of 60 octets. The size of the payload depends on the speech coding and frame sizes and may be as low as 15 to 20 octets. Thus, in case of voice traffic, IP, UDP and RTP may account for a couple of 100 percentages of overhead.

As the transmission capacity in radio access networks is often an expensive parameter for the cellular network operator, header compression is an attractive feature and in some environments, like in case of E1/T1 links, is often a necessity. Also in 3GPP (3^{rd} Generation Partnership Project) networks, IP header compression is used for low bandwidth links like E1.

Furthermore, in cellular networks, the traffic is expected to be asymmetric in terms of traffic volumes in two directions, i.e. uplink direction and downlink direction. Streaming, interactive and background type of UMTS (Universal Mobile Telecommunications System) services are gaining popularity, the asymmetricity becomes more and more significant. In today's transmission solutions, it is difficult to gain any advantage of the asymmetric nature of traffic. Instead, the transmission is dimensioned according the more loaded direction, that is, the downlink direction. As a result, a significant portion of available bandwidth may be continuously unused in the uplink direction. At the same time, application of header compression may be limited due to the needed processing power in the compressing/decompressing and of the transmission link. This limitation leads to a maximum number of compressed flows allowed to use the link, i.e. a maximum number of contexts which may exist concurrently.

### SUMMARY OF THE INVENTION

The present invention is an effective header compression scheme which is especially suitable for the conditions in cellular networks.

A method of controlling header compression in a packet data network, in accordance with the invention comprises the steps of: obtaining a load information of the packet data network; evaluating the load information; and triggering the header compression in response to the result of the evaluation step.

Furthermore, a system for controlling header compression in a packet data network, in accordance with the invention comprises: generating means for generating load information of the packet data network; evaluating means for evaluating the load information; and triggering means for triggering the header compression in response to the result of the evaluation by the evaluating means.

A network device for controlling header compression in a packet data network in accordance with the invention comprises: generating means for generating load information of the packet data network; evaluating means for evaluating the load information; and message generating means for generating a message for triggering the header compression, in response to the evaluation by the evaluating means.

A network device for controlling header compression in a packet data network in accordance with the invention comprises: receiving means for receiving a message for triggering the header compression; and compressing means for performing the header compression in response to the receipt of the message by the receiving means.

Accordingly, the new header compression scheme of the invention provides an on-demand header compression which takes into account the fact that header compression is a processing intensive task. With the invention, headers are compressed only on demand where the traffic volume is high and where, in effect the transmission capacity is the bottleneck. As a result, overall header compression takes less processing power and thus allows more flows to be compressed. The net benefit is that the transmission network can support more traffic in terms of number of streams and capacity but with the same amount of processing power in terms of network processors.

A direction dependent header compression may be selected if the load information indicates an asymmetric load distribution on the concerned link. Thus, header compression can be applied only for one direction provided that the load information indicates asymmetry. When the header compression is done only for one direction instead of both directions of the concerned link, significant processing power savings can be expected, irrespective of the fact that there may be a difference in the needed processing power between the compressor and the decompressor. The per-direction approach allows the system to take into account the expected asymmetricity of the traffic within the access network.

The load information may be obtained from load statistics provided at network interfaces, and/or obtained indirectly from an O&M server and a transport resource managing entity.

Furthermore, the evaluation may be performed based on a predetermined load threshold. Then, the header compression may be configured by using an operation and maintenance (O&M) command of the packet data network, or alternatively the header compression may be configured by performing a header negotiation using a network control protocol. In the latter case, a direction information for the header compression may be conveyed in a suboption field of a configuration option message. This direction information may be provided in a TLV format. The direction information may be adapted to selectively indicate a forward direction, a reverse direction or both.

### BRIEF DESCRIPTION OF THE DRAWINGS

In the following, the present invention will be described in greater detail on the basis of preferred embodiments with reference to the drawings, in which:

FIG. 1 shows a network architecture in which the present invention can be applied;

FIG. 2 shows a format of a configuration option message;

FIG. 3 shows a schematic block diagram of a transmission link according to the preferred embodiments of the present invention; and

FIG. 4 shows a signaling diagram of a compression negotiation according to a first preferred embodiment.

### DESCRIPTION OF THE PREFERRED EMBODIMENTS

The present invention will now be described on the basis of an IP based radio access network (IP RAN) as shown in FIG. 1.

IP RAN is a radio access network platform based on IP transport technology. It supports legacy interfaces towards core networks and legacy RANs, as well as legacy terminals, e.g. GSM/EDGE radio access network (GERAN) terminals or UMTS Terrestrial Radio Access Network (UTRAN) terminals. In IP RAN, most of the functions of former centralized controllers, e.g. radio network controller (RNC) and base station controller (BSC), are moved to the base station devices. In particular, all radio interface protocols are terminated in the base station devices. Entities outside the base station devices are needed to perform common configuration and some radio resource or interworking functions. Moreover, an interface is needed between the base station devices to support both control plane signaling and user plane traffic. Full connectivity among the network entities is supported over an IPv6 transport network.

According to FIG. 1, a plurality of IP base transceiver stations (IP BTS) 12, 14, 16 are connected to an IP network 70, e.g. an IPv6 network, which comprises a plurality of routers 20, 22, 24 and a radio network gateway (RNGW) 60 which provides an access point to the IP network 70 from core networks and/or other RANs. During a radio access bearer assignment procedure, the IP RAN returns to their respective core network transport addresses owned by the RNGW 60, where the user plane shall be terminated. Packet switched and circuit switched interfaces are connected through the RNGW 60. The main function of the RNGW 60 is the micro-mobility anchor, i.e. the user plane switching during a BTS relocation or handover, in order to hide the mobility to the core network. Due to this function, it need not to perform any radio network layer processing on the user data, but it relays data between the RAN and core network IP tunnels.

In the IP RAN architecture, all data whether it be voice over IP, video, email, etc. are treated as just data packets with different characteristics. The IP RAN can operate regardless of the core network employed. This core network could be circuit switched, packet switched or an IP core network. The control functionality of the former radio network controller (RNC) is now present in a radio network access server (RNAS) 40 and partially in the IP BTSs 12, 14, 16. All traffic will flow through the RNGW 60. Thus, the structure of the IP RAN network has changed from a hierarchical to a distributed network. This distributed architecture includes three new general purpose servers, a common radio resource management server (CRRM) 30 which provides radio resource management across multiple cell layers and base station subsystems (BSS), the RNAS 40 which controls active terminals, paging and cell broadcast, and an operations and maintenance server (OMS) 50 which provides operator access to change parameters and monitor the radio access network. This new IP RAN architecture leads to an increased routing efficiency by distributing the IP packets through different routes from the RNGW 60 to the IP BTSs 12, 14, 16 and via at least one radio connection a mobile terminal or user equipment 10, and vice versa. Thus, operators have the possibility to dynamically pool the servers to serve the whole radio access network instead of one or two base station devices. This many-to-many configuration helps to extend the characteristics of IP networks to the edge of the radio access networks.

In the IP BTSs 12, 14, 16, increased functionality is added to facilitate quality of service in real time and non-real time services. This is achieved by locating time critical radio functions closer to the air interface. Each IP BTS 12, 14, 16 is given the ability to prioritize packets based on their characteristics. This enables a QoS-based statistical multiplexing of the IP access traffic. Due to this, QoS can be more easily guaranteed and capacity gains can already achieved at base station level through prioritizing at the IP BTS instead of the former RNC. Moreover, the IP BTS 12, 14, 16 are adapted to reduce load by optimizing the location of a macro diversity combining point. Through the OMS 50, the operator can configure the parameters of the IP RAN to best suite the changing needs of the network. In case of failures, the operator can control the elements of the IP RAN to minimize and test potential problems. In particular, autotuning features can be provided to automatically get the best performance and the ability to broadcast system information to all elements at once.

In the preferred embodiments, header compression is applied on demand and may specifically be performed on an individual direction bases. Taking into account the fact that header compression is a processing intensive task, it is beneficial to perform it only on demand. The demand can be derived from the interface load statistics available e.g. in every network interface card of end nodes, e.g. IP-BTS 12, 14, 16, or routers 20, 22, 24 for operation and maintenance (O&M) purposes and the like. In particular, the header compression may be applied only for one direction if the load information obtained from the load statistics indicates an asymmetric transmission load, i.e. the load differs in the uplink and downlink directions. The header compression is then started or triggered when a predetermined criterion or trigger indicates the need for it. The directional header compression functionality may be based on the IETF (Internet Engineering Task Force) specification RFC 3095 (Robust Header Compression (ROHC)), in which a unidirectional compression mode is specified, which can be used on both uni- and bidirectional connections. Cellular links, which are a primary target for ROHC have a number of specific characteristics.

A data packet is a data unit of transmission and reception. Specifically, the packet is compressed and then decompressed by ROHC. A packet stream is a sequence of packets where the field values and change patterns of field values are such that the headers can be compressed using the same context. The context of the compressor is the state it uses to compress a header. The context of the decompressor is the state it uses to decompress a header. Either of these or the two in combination are usually referred to as “context”. The context contains relevant information from previous headers in the packet stream, such as static fields and possible reference values for compression and decompression. Moreover, additional information describing the packet stream may be also part of the context, for example information about how the IP identifier field changes and the typical inter-packet increase in sequence number or time stamps.

ROHC uses a distinct context identifier space per channel and can eliminate context identifiers completely for one of the streams when few streams share a channel. The ROHC protocol achieves its compression gain by establishing state information at both ends of the link, i.e. at the compressor and at the decompressor. Different parts of the state are established at different times and with different frequency. Hence, it can be said that some of the state information is more dynamic than the rest. Some state information is established at the time a channel is established, wherein ROHC assumes the existence of an out-of-band negotiation protocol, such as the point-to-point protocol (PPP), or predefined channel state. Other state information is associated with the individual packet streams in a channel.

The header compression protocol is specific to the particular network layer, transport layer or upper layer protocol combinations, e.g. TCP/IP and RTP/UDP/IP. The network layer protocol type, e.g. IP or PPP, is indicated during the packet data protocol context activation. The following preferred embodiments is related to a transport network layer header compression. The transport network layer IP is used for conveying user traffic over RAN interfaces, such as lub, lur and lu, while the header of corresponding UDP/IP datagrams or packets can be compressed.

In order to establish compression of IP datagrams or packets sent over a PPP link, each end of the link must agree on a set of configuration parameters or the compression. The process of negotiating link parameters for network layer protocols is handled in PPP by a family of network control protocols (NCPs), which may comprise separate NCPs for IPv and IPv6. Further details regarding the use of NCP in header compression can be gathered from the IETF specifications RFC 2509 and RFC 3241.

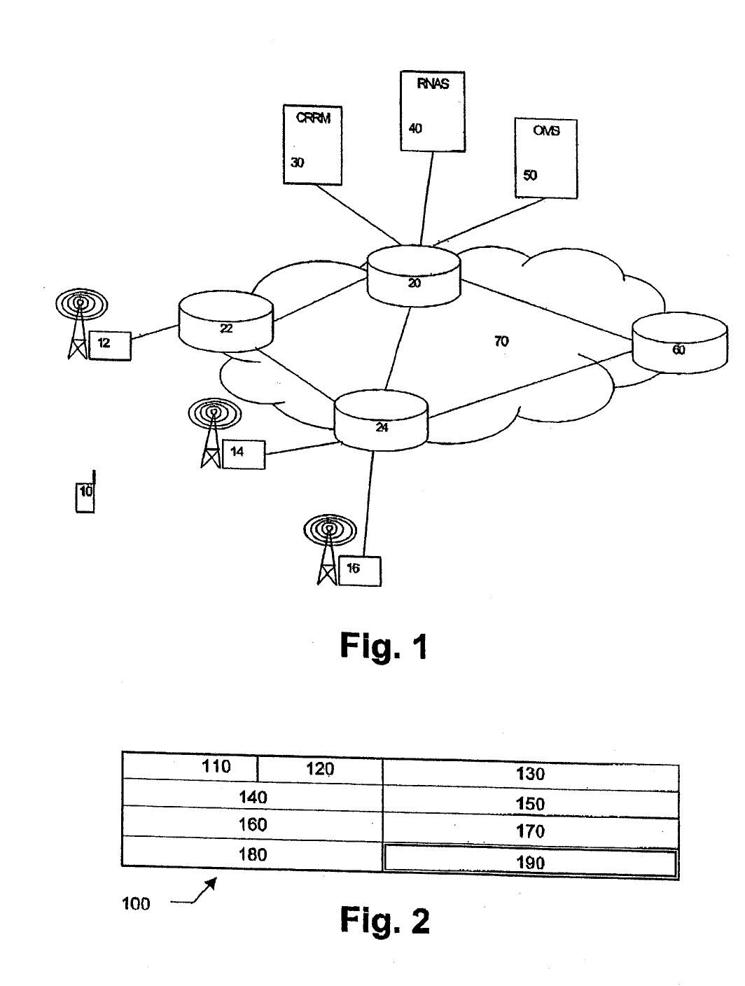

FIG. 2 shows a format of a configuration option message which is an IP compression protocol option which may be used for negotiating IP header compression parameters of a receiver or of a transmitter. The configuration option message comprises a type field 110 and a length field 120 for indicating the type and length, respectively, of the configuration option message. The length may be increased if additional parameters are added to the configuration option message. Furthermore, an IP compression protocol field 130 is provided for indicating the type of IP compression protocol. A TCP-SPACE field 140 indicates the maximum value of a context identifier in the space of context identifiers allocated for TCP, and a NON_TCP_SPACE field 150 indicates the maximum value of a context identifier in the space of context identifiers allocated for non-TCP. Additionally, an F_MAX_PERIOD field 160 is provided for indicating the maximum interval between full headers, and an F_MAX_TIME field 170 indicates the maximum time interval between full headers. A MAX_HEADER field 180 indicates the largest header size in octets that may be compressed. This value should be large enough to cover common combinations of network and transport layer headers. Finally, a suboptions field 190 is provided, which is emphasized in FIG. 2 due to its specific role in the present invention. The suboptions field 190 consists of zero or more suboptions. Each suboption consists of a type field, a length field and zero or more parameter octets, as defined by the suboption type. The value of the length field indicates the length of the suboption in its entirety, including the lengths of the type and length fields.

To allow the on-demand negotiation of header compression for one direction only, the suboptions field 190 can be used for conveying the direction information. This information can be in the TLV format, according to which a type, length and direction is defined. The direction information may define a forward direction, a reverse direction and/or both, thus indicating the direction(s) in which the header compression is to be applied. Due to the use of this suboptions field, the standardization of this new direction parameter is not necessary as such.

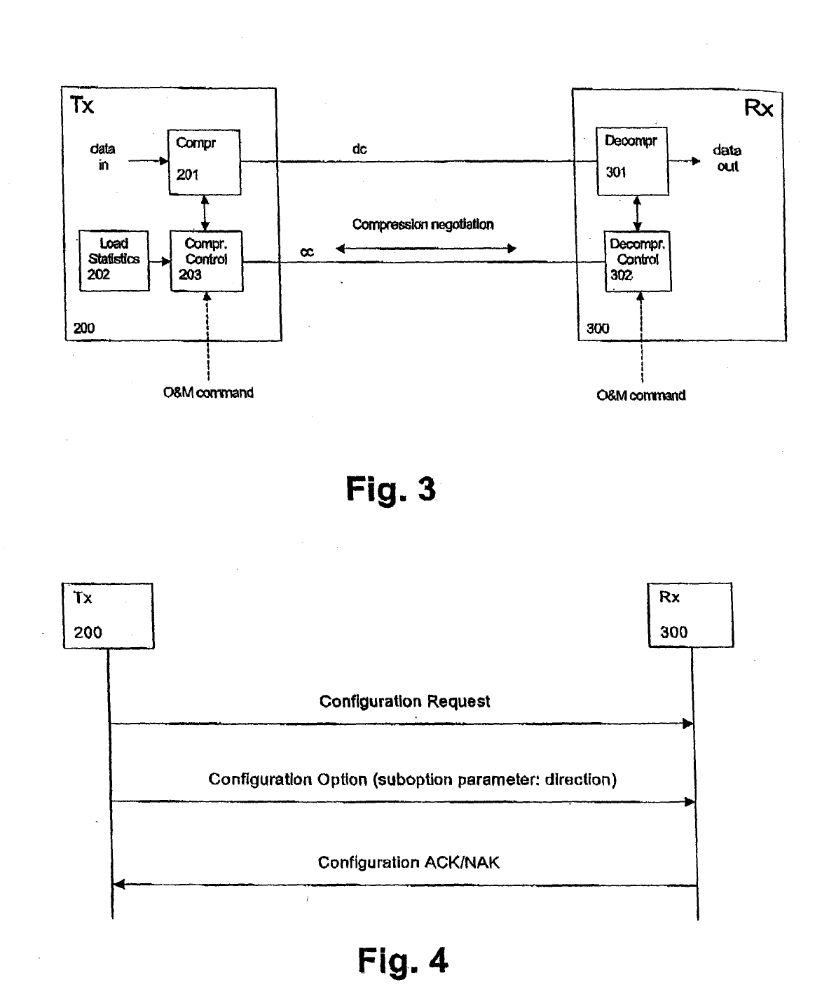

FIG. 3 shows a schematic diagram indicating a connection between a transmitting part 200 of a transmitting network device and a receiving part 300 of a receiving network device. These transmitting and receiving devices may be an IP BTS 12, 14, 16 or the RNGW 60, respectively, via selected ones of the routers 20, 22, 24 of the IP network 70.

According to the first preferred embodiment, the on-demand compression is initiated by an outband compression negotiation via a control channel cc, which may be a physical or logical channel. The transmitter 200 comprises a compressor 201 which compresses input data and forwards it to a decompressor 301 at the receiving device 300 via a data channel dc, which also may be a physical or logical channel. The compression context is controlled by a compression control unit 203 based on a load information obtained from load statistics of a network interface card 202. The compression negotiation is performed by the compressor control unit 203 and a decompressor control unit 302 which controls the decompression based on the compression context.

FIG. 4 shows a signaling diagram indicating a compression negotiation signaling according to the first preferred embodiment. After a configuration request is sent from the transmitting part 200 to the receiving part 300, the transmitting part 200 sends the configuration option message including the direction information as the suboption parameter in the suboptions field 190 of the configuration option message. In general, as already mentioned, this configuration option message is used to indicate the ability to receive compressed packets. Each end of the link must separately request this option if bi-directional compression is desired. I.e., the option describes the capabilities of the decompressor of the receiving part of the transmitting device. In response to the receipt of the configuration request and the configuration option, the receiving part 300 sends a configuration response, which may be an acknowledgement (ACK) or a non-acknowledgement (NACK). In case of a non-acknowledgement or configuration rejection, the transmitting part 200 may react by reducing the number of options offered.

To achieve the on-demand compression, the compression control unit 203 of the transmitting part 200 may continuously or at predetermined time intervals evaluate the load information obtained from the load statistics of the network interface card 202 and may then trigger a compression negotiation for a respective link based on the result of the evaluation. As an example, the evaluation may be performed by comparing the load situation of the concerned link with a predetermined load threshold in each direction and deciding on a bidirectional or unidirectional header compression.

According to a second preferred embodiment, the on-demand compression and specifically the directional compression can be configured via an O&M network functionality, e.g. the OMS 50. In this case, no specific compression negotiation signaling is required. The OMS 50 or any other network device responsible for O&M sends a O&M command to the respective transmission and receiving part of the concerned link, as indicated by the broken arrow in FIG. 3. The O&M command may comprise the same suboptions field as used in the configuration option message of the compression negotiation. The OMS 50 then performs an evaluation of the load situation in the network or in the concerned link based on load statistics obtained from the network and triggers a unidirectional or bidirectional compression based on the load evaluation, e.g. based on a comparison of the respective load with a predetermined load threshold.

As in the first preferred embodiment, the load threshold may be applied individually for each transmission direction, so as to decide on a unidirectional or bidirectional header compression. Based on the result of the load evaluation, the OMS 50 then issues a corresponding O&M command to the compression control unit and decompression control unit of the corresponding transmission ends of the concerned link.

It is noted, that the present invention is not restricted to the above preferred embodiments, but can be implemented in any packet data network. The packet data network monitors its processing capacity and/or congestion level in order to decide when to switch between header compressed and normal transmission modes. This monitoring and triggering operation may be performed by any network device having a radio network controlling functionality, e.g. a radio network controller (RNC) of a cellular network. In particular, the compression can be done for uplink and downlink separately, based on the asymmetricity of the traffic. The preferred embodiments may thus vary within the scope of the attached claims.

1. A method of controlling header compression in a packet data network, the method comprising the steps of:
a) obtaining load information of the packet data network;
b) evaluating the load information; and
c) triggering the header compression in response to the result of the evaluation step.

2. A method according to claim 1, further comprising the step of selecting a direction dependent header compression if the load information indicates an asymmetric load distribution on a concerned link.

3. A method according to claim 1, wherein the load information is obtained from load statistics provided at network interfaces.

4. A method according to claim 2, wherein the load information is obtained from load statistics provided at network interfaces.

5. A method according to claim 1, comprising the step of performing the evaluation step based on a predetermined load threshold.

6. A method according to claim 2, comprising the step of performing the evaluation step based on a predetermined load threshold.

7. A method according to claim 3, comprising the step of performing the evaluation step based on a predetermined load threshold.

8. A method according to claim 4, comprising the step of performing the evaluation step based on a predetermined load threshold.

9. A method according to claim 1, comprising the step of configuring the header compression by using an operation and maintenance command of the packet data network.

10. A method according to claim 2, comprising the step of configuring the header compression by using an operation and maintenance command of the packet data network.

11. A method according to claim 3, comprising the step of configuring the header compression by using an operation and maintenance command of the packet data network.

12. A method according to claim 4, comprising the step of configuring the header compression by using an operation and maintenance command of the packet data network.

13. A method according to claim 5, comprising the step of configuring the header compression by using an operation and maintenance command of the packet data network.

14. A method according to claim 6, comprising the step of configuring the header compression by using an operation and maintenance command of the packet data network.

15. A method according to claim 7, comprising the step of configuring the header compression by using an operation and maintenance command of the packet data network.

16. A method according to claim 8, comprising the step of configuring the header compression by using an operation and maintenance command of the packet data network.

17. A method according to claim 1, comprising the step of performing a header negotiation using a network control protocol.

18. A method according to claim 2, comprising the step of performing a header negotiation using a network control protocol.

19. A method according to claim 3, comprising the step of performing a header negotiation using a network control protocol.

20. A method according to claim 4, comprising the step of performing a header negotiation using a network control protocol.

21. A method according to claim 6, comprising the step of conveying a direction information for the header compression in a suboption field of a configuration option message.

22. A method according to claim 18, comprising the step of conveying a direction information of the header compression in a suboption field of a configuration option message.

23. A method according to claim 19, comprising the step of conveying a direction information of the header compression in a suboption field of a configuration option message.

24. A method according to claim 20, comprising the step of conveying a direction information of the header compression in a suboption field of a configuration option message.

25. A method according to claim 21, comprising the step of providing the direction information in a TLV format.

26. A method according to claim 21, comprising the step of adapting direction information to selectively indicate at least one of a forward direction or a reverse.

27. A method according to claim 25, comprising the step of adapting direction information to selectively indicate at least one of a forward direction or a reverse.

28. A system for controlling header compression in a packet data network, the system comprising:
a) generating means for generating a load information of the packet data network;
b) evaluating means for evaluating the load information; and
c) triggering means for triggering the header compression in response to the result of said evaluation by the evaluating means.

29. A system according to claim 28, wherein the generating means comprises at least one of a network interface card, an operation and maintenance server and a transport resource managing entity.

30. A system according to claim 28, wherein the packet data network is a cellular network.

31. A system according to claim 29, wherein the packet data network is a cellular network.

32. A system according to claim 30, wherein the cellular network is an IP based radio access network.

33. A system according to claim 31, wherein the cellular network is an IP based radio access network.

34. A network device for controlling header compression in a packet data network, the network device comprising:
a) generating means for generating load information of the packet data network;
b) evaluating means for evaluating the load information; and
c) message generating means for generating a message for triggering the header compression, in response to the evaluation by the evaluating means.

35. A network device according to claim 34, wherein the network device is an operation and maintenance server of a radio access network.

36. A network device for controlling header compression in a packet data network, the network device comprising:
a) receiving means for receiving a message for triggering the header compression; and
compressing means for performing the header compression in response to the receipt of the message by the receiving means. 37. A network device according to claim 36, wherein the message is an operation and maintenance command.
